(19) United States
(12) Patent Application Publication
(10) Pub. No.: US 2025/0020252 A1
(43) Pub. Date: Jan. 16, 2025

(54) TUBULAR COUPLING SYSTEMS AND METHODS

(71) Applicant: Kinetic Pressure Control Ltd., Houston, TX (US)

(72) Inventors: Steven A. Angstmann, Houston, TX (US); Sean Laird, Houston, TX (US); Brent Garden, Houston, TX (US)

(73) Assignee: Kinetic Pressure Control Ltd., Houston, TX (US)

(21) Appl. No.: 18/711,603

(22) PCT Filed: Dec. 6, 2022
(86) PCT No.: PCT/US2022/052057

§ 371 Date: May 19, 2024

Related U.S. Application Data
(60) Provisional application No. 63/291,612, filed on Dec. 20, 2021.

(51) Int. Cl. F16L 37/107

(52) U.S. Cl. CPC F16L 37/107

(57) ABSTRACT

Releasable tubular couplings entailing spring-based designs providing a mechanical solution for linking/coupling tubulars. A method for forming a releasable coupling between a first tubular member and a second tubular member.

### CROSS REFERENCE TO RELATED APPLICATIONS

National stage entry of International Application No. PCT/US2022/052057 filed on Dec. 6, 2022. Priority is claimed from U.S. Provisional Application No. 63/291,612 filed on Dec. 20, 2021. Both applications are incorporated herein by reference in their entirety.

### BACKGROUND

This disclosure relates to the field of connectors. More specifically, the disclosure relates to techniques for linking/coupling tubulars and making releasable tubular junctions.

In offshore shale or coiled tubing and wireline work, there is a push to reduce working at heights and to make up connections quickly with pressure control equipment (e.g., lubricators, injectors, etc.). Conventional equipment is typically suspended/hoisted by a crane, which adds a level of complexity and increases the risk of injury to personnel. Thus, a need remains for improved techniques to quickly, efficiently, and safely link or couple equipment to tubulars.

### SUMMARY

One aspect of the present disclosure is a tubular coupling including a first tubular member; a second tubular member configured to receive an end of the first tubular member to form a junction; and a locking sleeve disposed on the first tubular member. The locking sleeve including a plurality of dogs extending therefrom proximate an end of the sleeve. The second tubular member including a plurality of raised lugs on a surface thereof. At least one spring is disposed on the first tubular member and configured to facilitate rotation of the locking sleeve about a longitudinal axis of the first tubular member. The locking sleeve is configured to rotate such that the plurality of dogs thereon: a) engage with the plurality of raised lugs on the second tubular member to form a locking engagement; and b) disengage from the plurality of raised lugs on the second tubular member to allow separation of the first tubular member from the second tubular member.

Another aspect of the present disclosure is a tubular coupling including a first tubular member; a second tubular member configured to link with the first tubular member to form a junction; and a locking sleeve disposed on the first tubular member. The locking sleeve includes a plurality of dogs extending therefrom proximate an end of the sleeve. The second tubular member includes a plurality of raised lugs on a surface thereof. A first spring is disposed on the first tubular member and configured to facilitate rotation of the locking sleeve in one direction about a longitudinal axis of the first tubular member. A second spring is disposed on the first tubular member and configured to facilitate rotation of the locking sleeve about the longitudinal axis of the first tubular member in a direction opposite the direction facilitated by the first spring. The locking sleeve is configured to rotate such that the plurality of dogs thereon: a) engage with the plurality of raised lugs on the second tubular member to form a locking engagement; and b) disengage from the plurality of raised lugs on the second tubular member to allow separation of the first tubular member from the second tubular member.

A method of forming a releasable coupling between a first tubular member and a second tubular member according to another aspect of the disclosure includes linking the first tubular member with the second tubular member to enable rotation of a locking sleeve on the first tubular member about a longitudinal axis of the member; wherein at least one spring is disposed on the first tubular member to facilitate rotation of the locking sleeve. A locking engagement is formed between the first tubular member and the second tubular member by enabling rotation of the locking sleeve until a plurality of dogs on the sleeve engage with a plurality of raised lugs on the second tubular member; and disengaging the plurality of dogs on the locking sleeve from the raised lugs on the second tubular member by enabling further rotation of the locking sleeve allows separation of the first tubular member from the second tubular member.

### BRIEF DESCRIPTION OF THE DRAWINGS

FIG. 1 shows a tubular coupling embodiment according to this disclosure.

FIG. 2 shows an exploded view of a tubular coupling embodiment according to this disclosure.

FIG. 3 shows an exploded partial view a tubular coupling end according to this disclosure.

FIG. 4 shows a schematic of a tubular coupling end according to this disclosure.

FIG. 5 shows a schematic overhead view of the coupling end of FIG. 4.

FIG. 6 shows a view of tubular member according to this disclosure.

FIG. 7 shows a perspective view of the tubular member of FIG. 6.

FIG. 8 shows a schematic of a tubular coupling according to this disclosure.

FIG. 9 shows a schematic of a tubular coupling according to this disclosure.

FIG. 10 shows a schematic of a partial tubular coupling according to this disclosure.

FIG. 11 shows a schematic of a tubular coupling according to this disclosure.

FIG. 12 shows a schematic of a tubular coupling according to this disclosure.

FIG. 13 shows a schematic of a tubular coupling according to this disclosure.

FIG. 14 shows a schematic of a tubular coupling according to this disclosure.

FIG. 15 shows a schematic of a tubular coupling according to this disclosure.

FIG. 16 shows a schematic of another tubular coupling according to this disclosure.

FIG. 17 shows a schematic of the tubular coupling of FIG. 16.

FIG. 18 shows a schematic of tubular coupling components according to this disclosure.

FIG. 19 shows a schematic of a tubular member according to this disclosure.

FIG. 20 shows a schematic of a tubular coupling component according to this disclosure.

FIG. 21 shows a schematic of a tubular coupling according to this disclosure.

FIG. 22 shows a schematic of another tubular coupling according to this disclosure.

FIG. 23 shows a schematic of a tubular coupling according to this disclosure.

FIG. 24 shows a schematic of tubular coupling components according to this disclosure.

FIG. 25 shows a view of an oilfield operation entailing a tubular coupling according to this disclosure.

### DETAILED DESCRIPTION

Illustrative embodiments are disclosed herein. In the interest of clarity, not all features of an actual implementation may be described. In the development of any such actual embodiment, numerous implementation-specific decisions may need to be made to achieve the design-specific goals, which may vary from one implementation to another. It will be appreciated that such a development effort, while possibly complex and time-consuming, would nevertheless be a routine undertaking for persons of ordinary skill in the art having the benefit of this disclosure. The disclosed embodiments are not to be limited to the precise arrangements and configurations shown in the figures, in which like reference numerals may identify like elements. Also, the figures are not necessarily drawn to scale, and certain features may be shown exaggerated in scale or in generalized or schematic form, in the interest of clarity and conciseness.

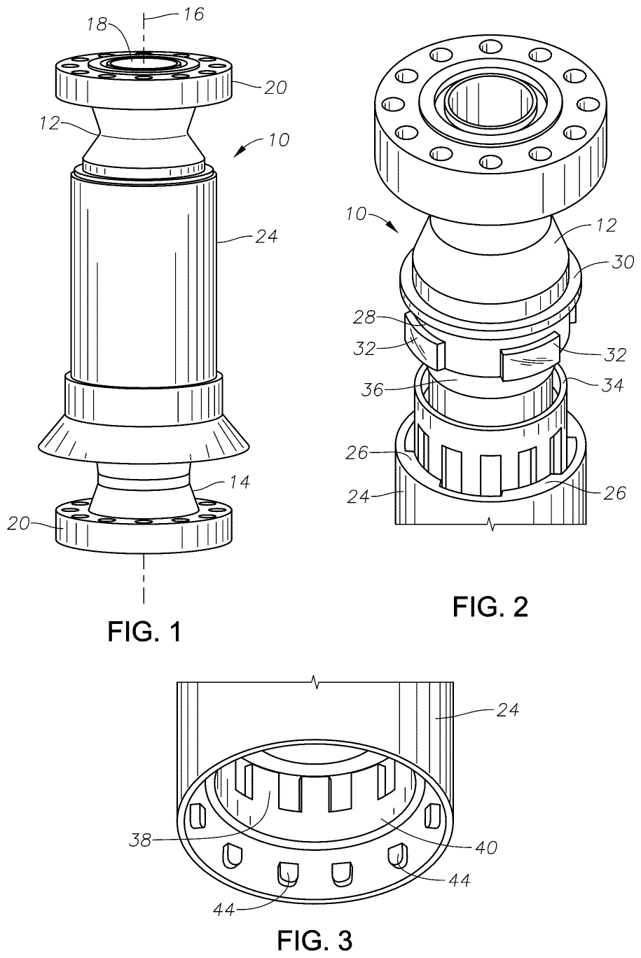

FIG. 1 shows a tubular coupling 10 of an example embodiment according to this disclosure. The tubular coupling 10 is shown in its fully assembled state. A first tubular member 12 is linked with a second tubular member 14 to form an elongated unit having a longitudinal axis 16. A through bore 18 traverses the assembled coupling 10 to provide an internal conduit (e.g., for fluid flow through the coupling). Each end of the coupling 10 is configured to link with another device such as a tool, equipment, or other component. In some embodiments, each end of the coupling 10 is implemented with a flange 20 type connector that can be bolted onto another device such as a tubular or tool. Other embodiments may be implemented with any conventional connecting interfaces to interpose and link the coupling 10 between devices. For example, coupling 10 embodiments may be implemented with conventional oilfield “pin” connections on each end, conventional oilfield “box” connections on each end, or a combination of pin/box connections on the respective ends.

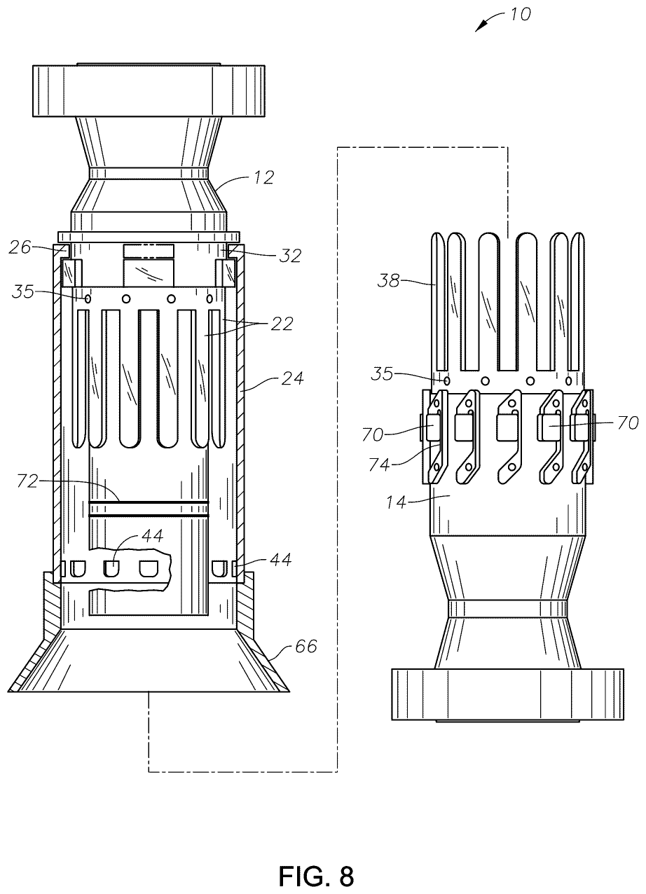

FIG. 2 shows a partially exploded view of a coupling 10 embodiment. The external surface of the first tubular member 12 is contoured to accommodate a first set of fingers 22, as further described below. A cylindrical locking sleeve 24 forms the exterior of the first tubular member 12. One end of the locking sleeve 24 is implemented with a plurality of tabs 26 extending radially inward. The tabs 26 are configured to respectively reside within a spacing 28 formed between a ring 30 on the first tubular member 12 and a plurality of shoulders 32 formed along the outer circumference of the member 12. As shown in FIG. 8, the shoulders 32 provide a supporting ledge for the tabs 26, maintaining the locking sleeve 24 on the first tubular member 12 while permitting rotation of the sleeve about the longitudinal axis 16 of the member.

The embodiment of FIG. 2 shows a first set of spaced-apart fingers 22 extending axially in parallel with the longitudinal axis 16 of the first tubular member 12. The fingers 22 extend axially downward from a base ring 34 which sits on a circumferential recess 36 formed on the member 12. The base ring 34 is rigidly affixed to the first tubular member 12 using any suitable securing means (e.g., mounted with countersunk bolts 35, welded, spline mating, etc.). The distal ends of the fingers 22 are preferably rounded (see FIG. 8).

FIG. 3 shows a partial exploded view of the lower end of a locking sleeve 24. FIG. 3 shows a second set of fingers 38 disposed within the locking sleeve 24. Similar to the first set of fingers 22, the second set includes a plurality of spaced-apart fingers 38 extending axially in parallel with the longitudinal axis 16 of the first tubular member 12. The fingers 38 extend axially upward from a base ring 40. Unlike the first set of fingers 22, the second set of fingers 38 is rigidly affixed to the second tubular member 14 (see FIG. 8). The base ring 40 sits on a circumferential recess 42 formed on the end of the second tubular member 12 (see FIG. 7). The base ring 40 is mounted to the second tubular member 14 using any suitable securing means (e.g., with countersunk bolts 35, welded, spline mating, etc.). The distal ends of the fingers 38 are preferably rounded (FIG. 8). FIG. 3 also shows the locking sleeve 24 implemented with a plurality of dogs 44 extending radially outward from the inner surface proximate an end of the sleeve. The dogs 44 are each preferably formed with a square flat top, square flat sides, and a rounded bottom.

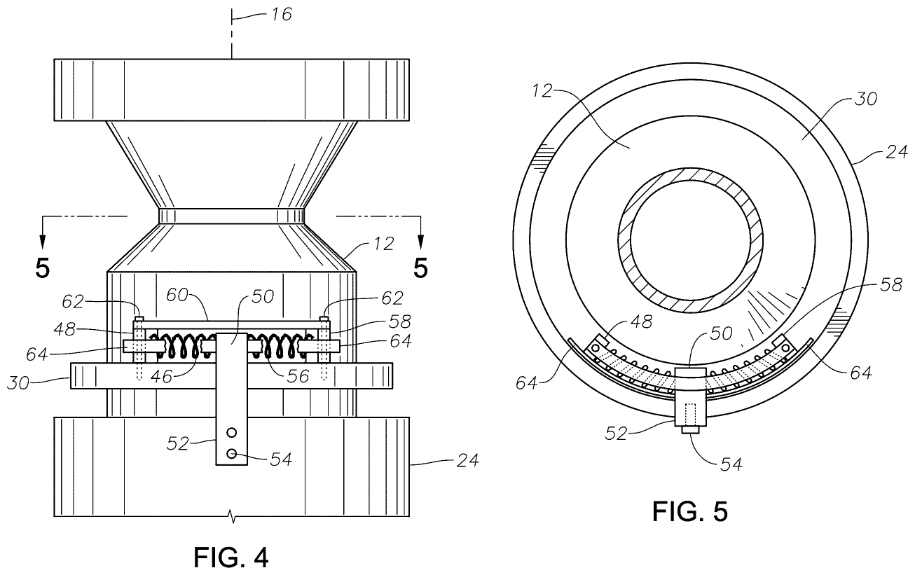

Turning to FIG. 4, a first tubular member 12 embodiment is shown implemented with a plurality of springs mounted thereon to facilitate rotation of the locking sleeve 24 about the longitudinal axis 16 of the first tubular member, as further described below. A first spring 46 resides on the ring 30, which acts as a supporting ledge. The first spring 46 is retained on one end by a first upright 48 and on the opposite end by a stop 50 (see FIG. 5) radially extending inward from a T-bar 52 mounted to the exterior of the locking sleeve 24 via a pair of bolts 54. A second spring 56 resides on the opposite side of the stop 50, retained on the other rend by a second upright 58. A retainer plate 60 is mounted above the springs 46, 56 to keep them in place. The retainer plate 60 is affixed to the first and second uprights 48, 58 by bolts 62 extending into the ring 30. The first and second springs 46, 56 are further retained on the first tubular member 12 by the extensions 64 of the T-bar 52.

FIG. 5 shows an overhead view of this embodiment. As configured, the locking sleeve 24 is free to rotate circumferentially about the longitudinal axis 16 of the first tubular member 12, to the extent permitted by the first and second springs 46, 56 and the respective uprights 48, 58. Although only one set of springs 46, 56 is shown disposed on the first tubular member 12, it will be appreciated that other embodiments may be implemented with a plurality of spring sets and respective T-bars distributed on the circumference of the first member.

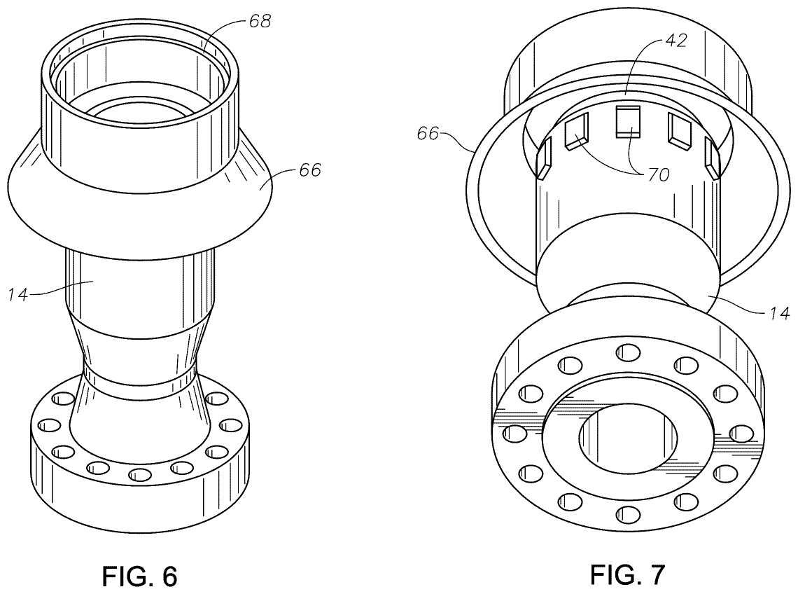

FIG. 6 shows the second tubular member 14 and a guiding cup 66 that aids in aligning the first tubular member 12 when linking the first member to the second tubular member 14. One end of the cup 66 is flared to guide and receive the second tubular member 14. The other end of the cup 66 is configured with a circumferential recess 68 for mounting the guiding cup 66 to the end of the first tubular member 12, as shown in FIG. 1. The guiding cup 66 may be affixed to the end of the first tubular member 12 via any suitable means as known in the art (e.g., welding, fasteners, etc.).

FIG. 7 shows another aspect of the second tubular member 14 and the guiding cup 66. As shown in FIG. 7, the end of the second tubular member 14 that links with the first tubular member 12 is configured with a plurality of raised lugs 70 disposed on the exterior circumference of the tubular member. The raised lugs 70 are preferably formed with flat square sides as shown in FIG. 7.

FIG. 8 shows a tubular coupling 10 embodiment with the first tubular member 12 as it is suspended above the second tubular member 14. As depicted in FIG. 8, when linking the two tubular members 12, 14, the guiding cup 66 automatically aligns the two components so that the lower end of the first tubular member 12 is received in the internal diameter of the upper end of the second tubular member 14. In some embodiments, the tubular body of the first tubular member 12 is implemented with one or more conventional seals 72 (e.g., O-rings in lands) on the exterior circumference to provide a fluid-tight engagement when the first tubular member is coupled into the second tubular member 14. FIG. 8 also shows a plurality of guide bars 74 mounted (e.g., via bolts 35) on the second tubular member 14. The guide bars 74 are configured to guide the plurality of dogs 44 on the locking sleeve 24 into a locking engagement with the plurality of raised lugs 70 on the second tubular member 12, and to disengage from the plurality of raised lugs on the second tubular member (further described below). Although not shown in FIG. 8 for clarity of illustration, at this stage the first and second springs 46, 56 are in a state of equilibrium, as shown in FIG. 4.

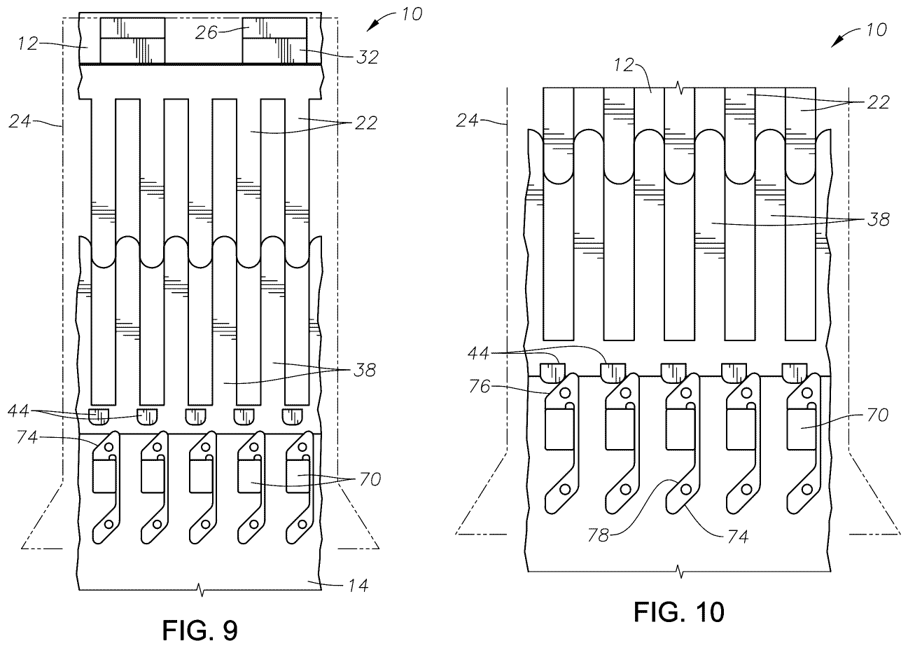

FIG. 9 shows the tubular coupling 10 as the first tubular member 12 is lowered to link with the second tubular member 14. As the first tubular member 12 is lowered, the sets of fingers 22, 38 begin to interlace with one another. FIG. 9 shows the first tubular member 12 lowered to the point where the dogs 44 on the locking sleeve 24 make contract with the guide bars 74 on the second tubular member 14. The first and second springs 46, 56 are still in a state of equilibrium.

FIG. 10 shows a closer view of the engagement between the first tubular member 12 and the second tubular member 14. Each guide bar 74 is configured with an upper ramp 76 and a lower ramp 78. As the first tubular member 12 is lowered to link with the second tubular member 14, each dog 44 on the locking sleeve 24 contacts the upper ramp 76 of each guide bar 74 and is guided along the ramp incline as shown in FIG. 10.

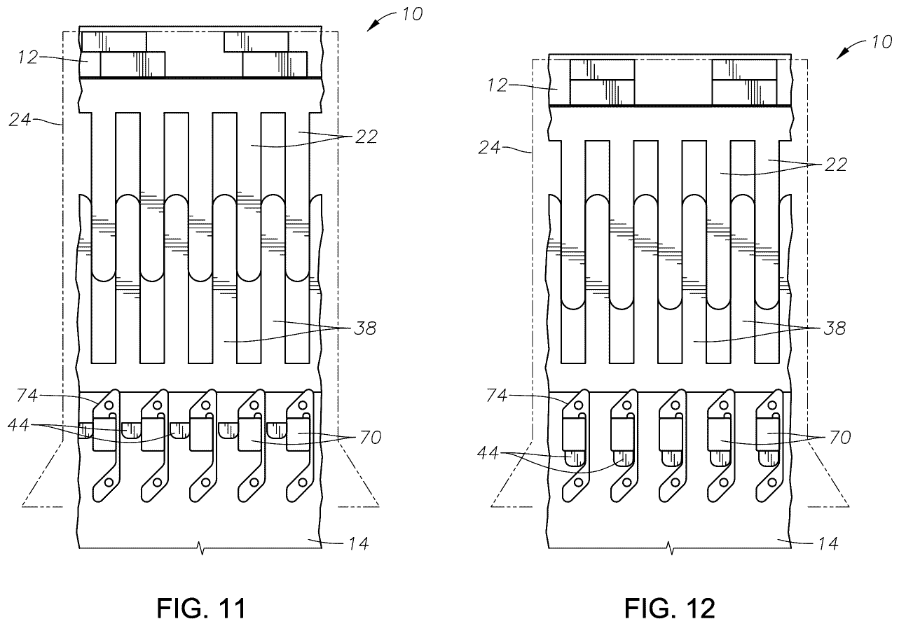

FIG. 11 shows the dogs 44 on the locking sleeve 24 sliding down into the channels between the raised lugs 70 on the second tubular member 14. The combined weight of the first tubular member 12, the locking sleeve 24, and whatever device may be connected above the first tubular member is sufficient to force the first tubular member into full engagement with the second tubular member 14 via gravity. At this stage, the first spring 46 is in a state of compression as the locking sleeve 24 rotates in a clockwise direction (to the left facing the drawing).

In FIG. 12, the first tubular member 12 has been lowered onto the second tubular member 14 until the dogs 44 on the locking sleeve 24 clear the raised lugs 70 and the compressed first spring 46 causes the sleeve to rotate in a counterclockwise direction (to the right facing the drawing) until the dogs 44 snap into a locking engagement below the lugs 70. Once in locking engagement, the first and second springs 46, 56 return to a state of equilibrium. The entire coupling 10 assembly can now be lifted into a state of tension.

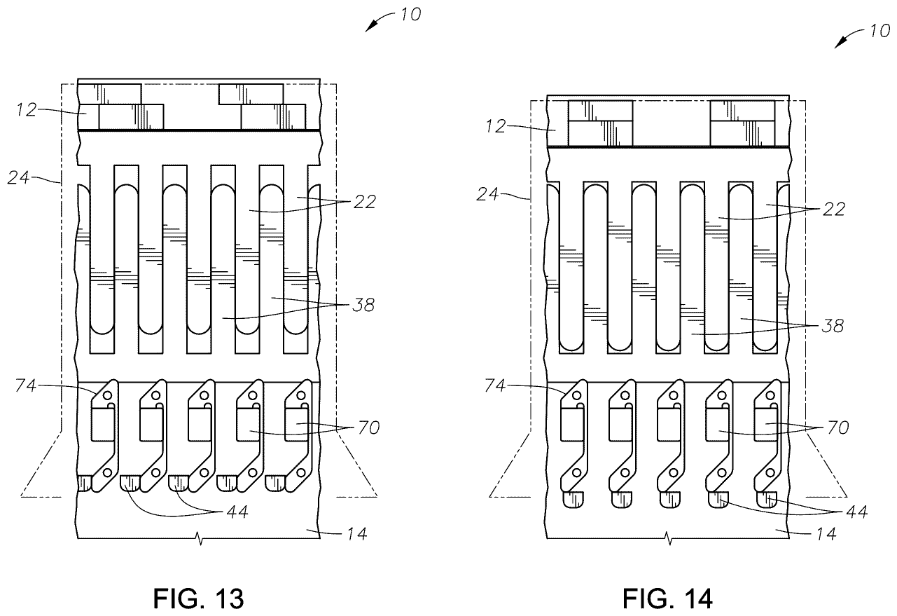

FIG. 13 shows the commencement of the coupling 10 unlocking sequence. The first tubular member 12 is lowered, allowing the dogs 44 to the slide down the lower ramps 78 of the guide bars 74. At this stage, the first spring 46 is in a state of compression. In FIG. 14, the first tubular member 12 is shown lowered until the dogs 44 have passed the lower ramps 78 of the guide bars 74. First and second springs 46, 56 have returned to a state of equilibrium.

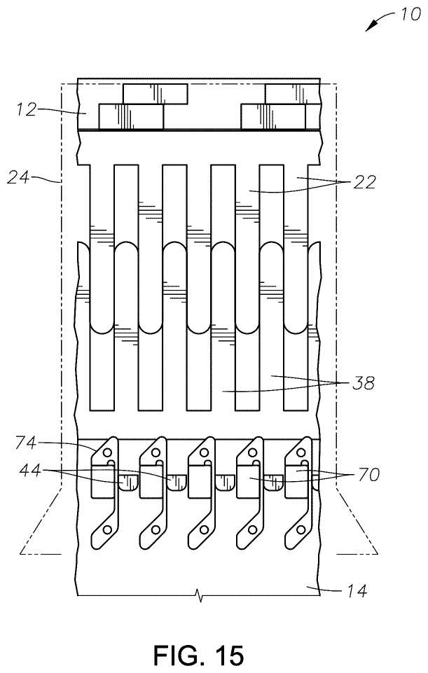

FIG. 15 shows the coupling 10 as the first tubular member 12 is lifted, forcing the dogs 44 to travel up the right side of the lower ramps 78. The locking sleeve 24 rotates in a counterclockwise direction (to the right facing the drawing) allowing the dogs 44 to slide into the channels between the raised lugs 70. At this stage, the second spring 56 is in a state of compression. Once the dogs 44 have passed over the guide bars 74, first and second springs 46, 56 return to a state of equilibrium. The first tubular member 12 can now be separated from the second tubular member 14, or lowered again to return the coupling 10 to a locked engagement.

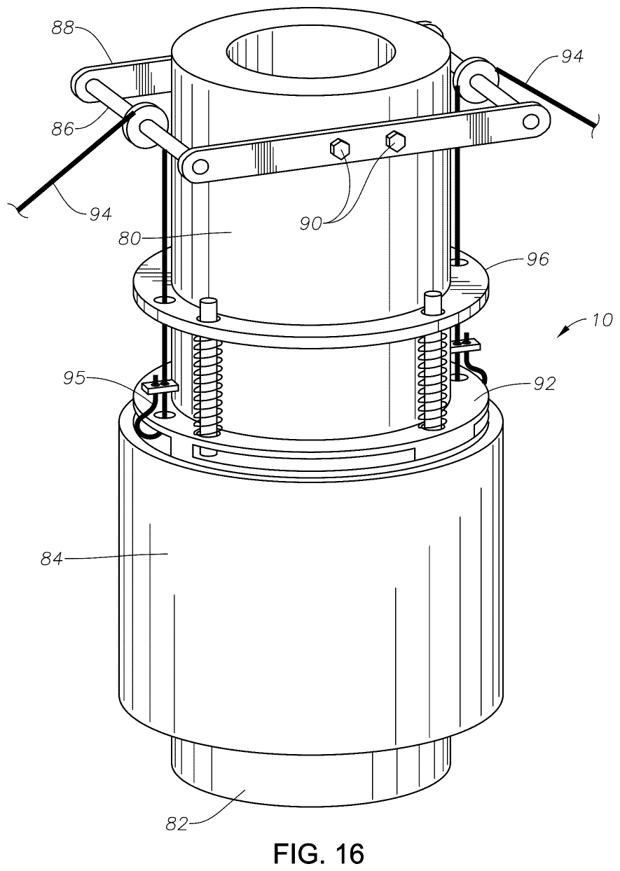

Turning to FIG. 16, another embodiment of a tubular coupling 10 is shown. In its assembled state, a first tubular member 80 is linked with a second tubular member 82. A rotatable locking sleeve 84 is disposed on the first tubular member 80. This embodiment also includes a pulley system 86 mounted on the first tubular member 80 via brackets 88 and bolts 90. A moveable locking pin ring 92 is disposed on the first tubular member 80 and latched to a pair of cables 94 by fasteners 95 for activation via the pulley system 86 as further described below. A stationary ring 96 is disposed on the first tubular member 80 above the locking pin ring 92. The stationary ring 96 is configured with holes 99 permitting passage of the cables 94 therethrough.

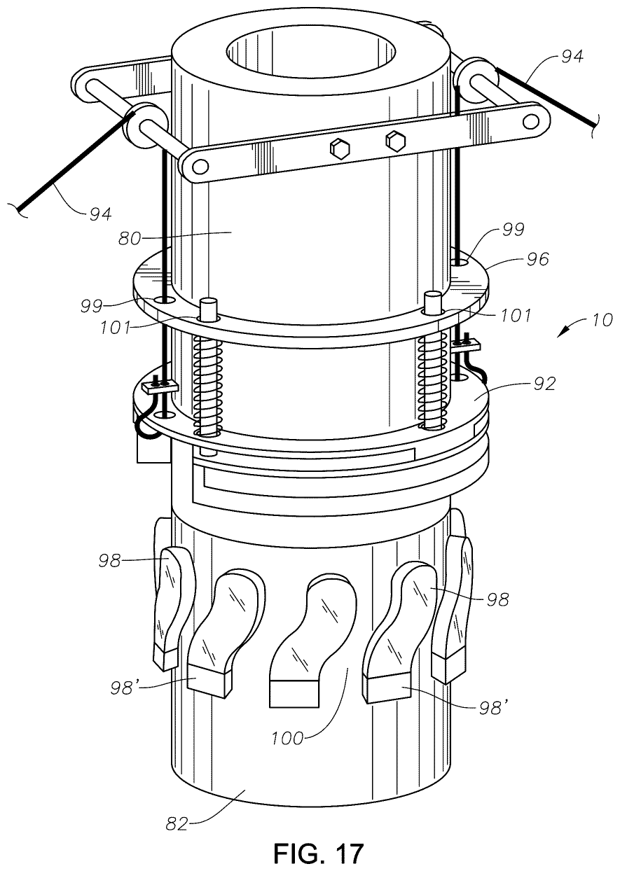

FIG. 17 shows the coupling 10 with the locking sleeve 84 removed. The second tubular member 82 is implemented with a plurality of raised lugs 98 disposed on the outer circumference of the member. The raised lugs 98 are configured to form curved channels 100 in between the lugs. Each raised lug 98 is preferably formed with a rounded upper end and a square flat bottom end. In some embodiments, the raised lugs 98 may each be implemented with two components, an upper component 98 and a lower component 98′. The upper component 98 may be formed separately and affixed to the second tubular member 82 via conventional means (e.g., bolted on, glued, welded, etc.). Since the lower component 98′ is a load bearing element, it is preferably formed integrally with the second tubular member 82.

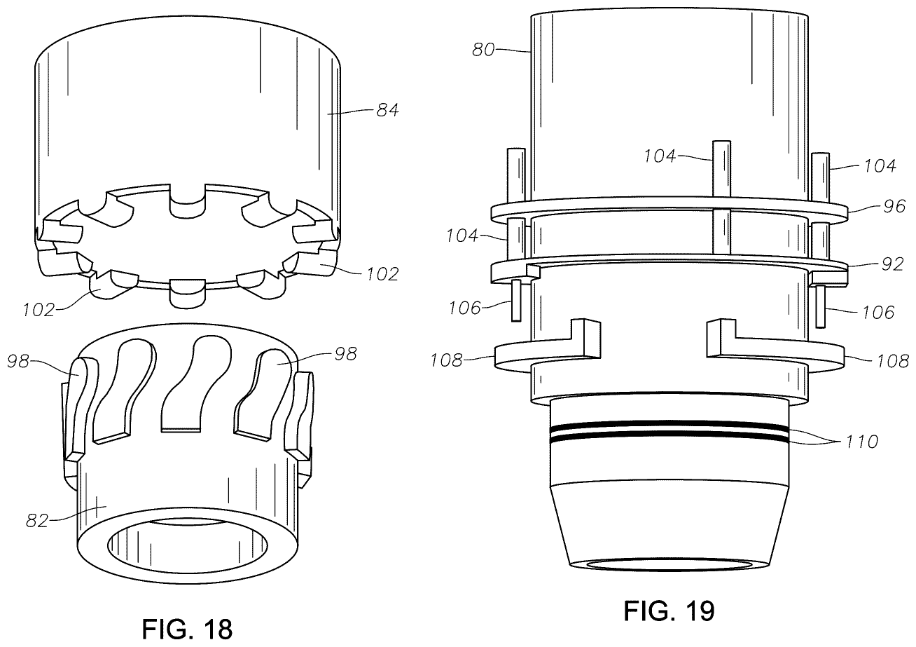

FIG. 18 shows an embodiment of a locking sleeve 84 and a second tubular member 82. The locking sleeve 84 is implemented with a plurality of dogs 102 extending radially toward the interior of the sleeve proximate the end of the sleeve. The dogs 102 are each preferably formed with a square flat top and a rounded bottom.

FIG. 19 shows an embodiment of a first tubular member 80. The locking pin ring 92 is implemented with a plurality of rods, each rod forming a guiding rod 104 extending from an upper surface of the ring 96 and a locking pin 106 extending from a lower surface of the ring 96. The stationary ring 96 is formed with holes (101 in FIG. 17) sufficiently large enough to permit the guiding rods 104 to freely move therethrough. The first tubular member 80 is also implemented with a plurality of cradles 108 extending outward from the exterior surface of the member. Embodiments may also be equipped with one or more conventional seals 110 (e.g., O-rings in lands) to ensure a fluid-tight seal when the first tubular member 80 is coupled with the second tubular member 82.

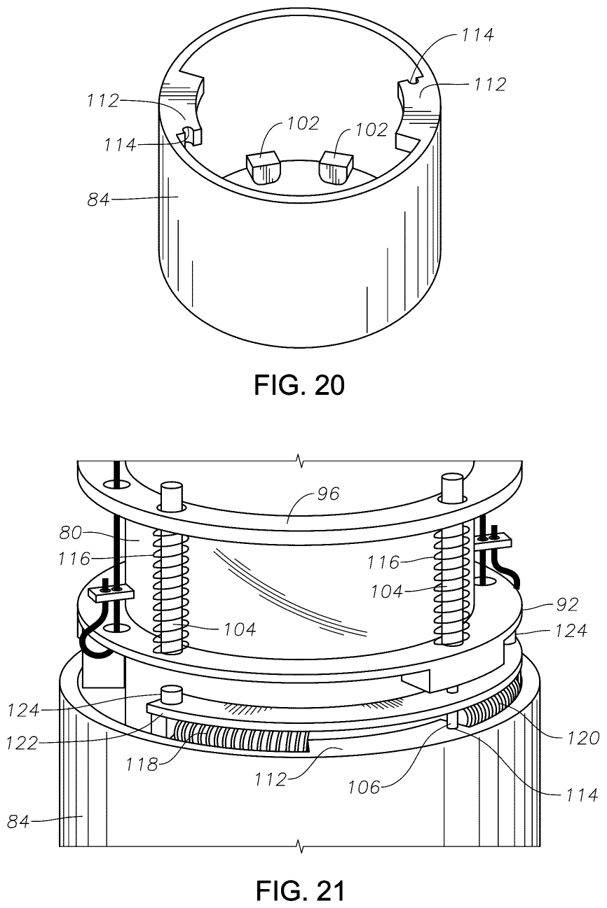

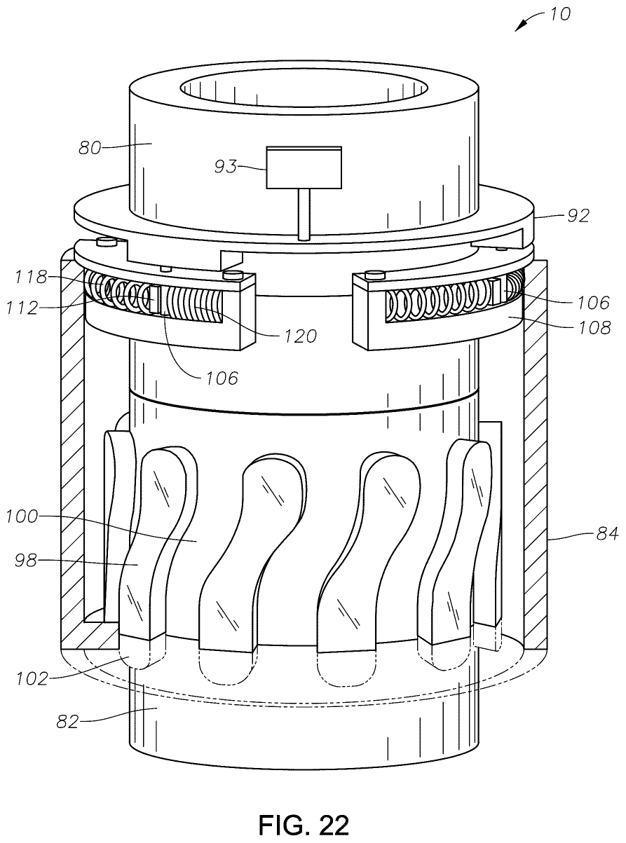

FIG. 20 shows an embodiment of a locking sleeve 84. The upper end of the locking sleeve 84 may be implemented with one or more tabs 112 extending radially inward from the inner surface of the member. The tabs 112 are configured to respectively reside within a spacing formed via the cradles 108 (see FIG. 21) on the first tubular member 80. As shown in FIG. 22, the cradles 108 provide a supporting ledge for the tabs 112, maintaining the locking sleeve 84 on the first tubular member 80 while permitting rotation of the sleeve about the longitudinal axis of the member. Each tab 112 is also formed with a notch 114 to accommodate the locking pin 106 (see FIG. 21).

FIG. 21 shows the first tubular member 80 configured with a plurality of springs. Each guiding rod 104 is fitted with a spring 116 disposed on the rod between the locking pin ring 92 and the stationary ring 96. Since the stationary ring 96 is rigidly affixed to the first tubular member 80, the springs 116 maintain a force against the locking pin ring 92. Each cradle 108 (see FIG. 19) houses a first spring 118 and a second spring 120. The first and second springs 118, 120 are separated by the tab 112 on the locking sleeve 84. A retainer plate 122 is mounted above the springs 118, 120 to keep them in place. The retainer plate 122 is affixed to the cradle 108 by bolts 124.

As shown in FIG. 21, the second spring 120 is retained in a compressed state within the cradle 108 by the retaining pin 106. The first spring 118 is in a relaxed state. In this state, when the first tubular member 80 is lowered onto the second tubular member 82, the dogs 102 on the locking sleeve 84 slide down along the channels 100 formed between the raised lugs 98. FIG. 22 shows such linking of the first and second tubular members 80, 82. As the first tubular member 80 is lowered, the locking sleeve 84 rotates clockwise (to the left facing the drawing), placing the first spring 118 in a state of compression. When the first tubular member 80 is lowered to the point where the dogs 102 clear the bottom of the raised lugs 98, the first spring 118 pushes the locking sleeve 84 counterclockwise (to the right facing the drawing) until the dogs 102 snap into locking engagement with the ends of the raised lugs 98, as shown in FIG. 22. At this stage the first spring 118 returns to a relaxed state. The entire coupling 10 assembly can now be lifted into a state of tension.

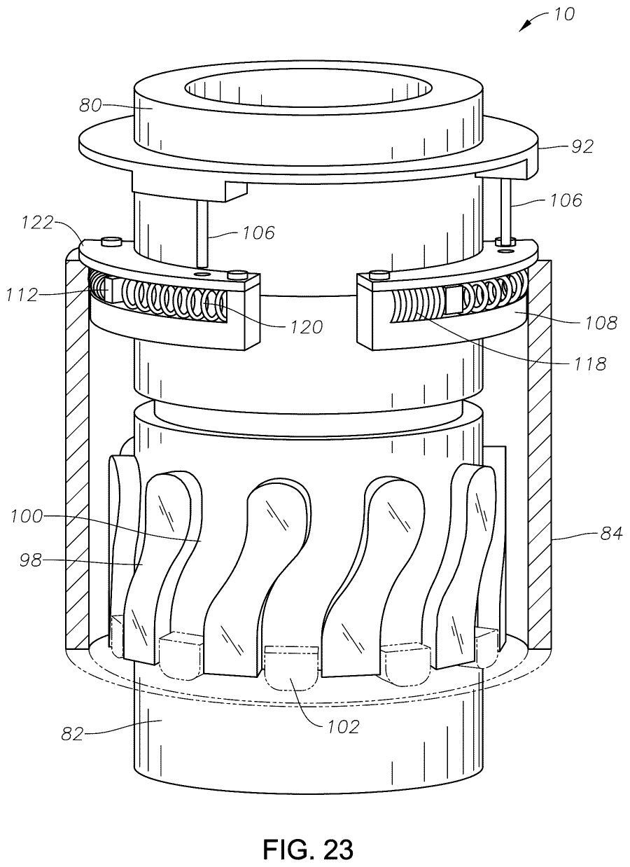

FIG. 23 shows the decoupling sequence. To disengage the first and second tubular members 80, 82, the locking pin ring 92 is lifted upward, which in turn raises the locking pins 106 to free the compressed second springs 120 in the cradles 108. As shown in the embodiments of FIGS. 16 and 17, the locking pin ring 96 may be lifted by pulling on the cables 94 with sufficient tension to overcome the force of the springs 116 on the guiding rods 104. It will be understood by those skilled in the art that other embodiments may be implemented with conventional means for remote selective release of the locking pins 106 to disengage the coupling 10 tubular members 80, 82. For example, an embodiment may be implemented with a conventional battery powered push-pull plunger solenoid 93 to wirelessly trigger elevation of the locking pin ring 92, as shown in FIG. 22.

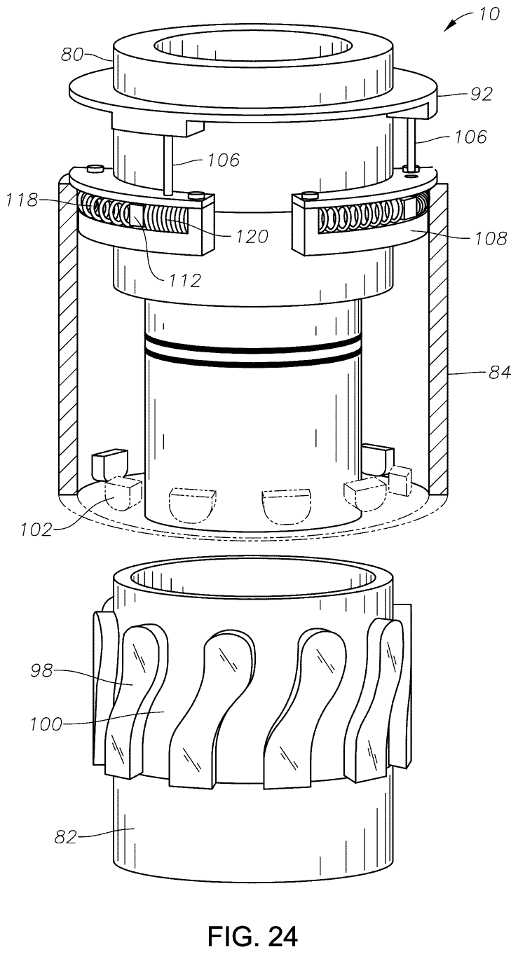

Once the locking pin ring 92 is lifted to release the second springs 120, the springs push on the tabs 112 to rotate the locking sleeve 84 clockwise (to the left facing the drawing), thereby shifting the dogs free from engagement with the raised lugs 98 and in alignment with the channels 100, as shown in FIG. 23. The first tubular member 80 can now be separated from the second tubular member 82, as shown in FIG. 24. It will be understood that all tubular coupling 10 embodiments of this disclosure may be configured with conventional interfaces to link the coupling to desired devices.

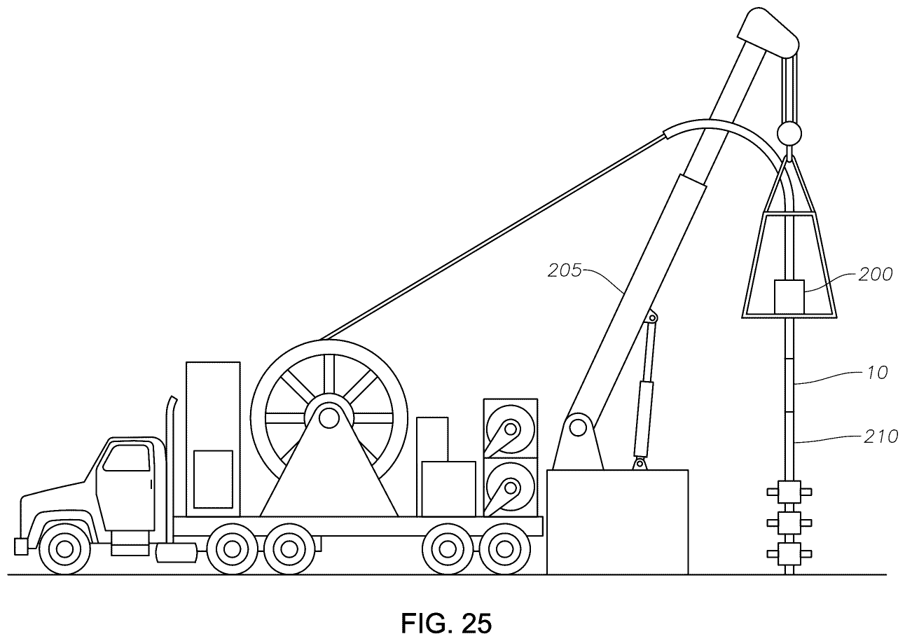

FIG. 25 shows a coiled tubing operation as is common in the oil and gas industry. Such operations generally require that equipment 200 be hoisted and kept elevated by a crane 205 for the duration of the entire application. Tubing connections to the equipment 200 have typically required a rig hand on a lift or scaffolding equipment to manually make the connections while the equipment is held elevated. Not only is this a time-consuming endeavor, it also exposes the rig hands to high risk of injury. The tubular coupling 10 embodiments of this disclosure provide a safer, reliable, and more efficient manner of making such couplings between tubulars. FIG. 25 shows a coiled tubing operation as carried out using a tubular coupling 10 of this disclosure. With the coupling 10, the upper end of the first tubular member 12 may be coupled to the equipment 200 and the lower end of the second tubular member 14 may be coupled to the tubular to be linked to the equipment. This can be accomplished at ground level without the need for a rig hand to use a lift or scaffolding. With the two coupling 10 member halves 12, 14 linked in this manner, the equipment 200 can then be hoisted to position with the first tubular member 12 extending below ready for linking with the second tubular member 14 affixed to the tubular 210. The equipment 200 can then be lowered into position such that the first tubular member 10 links with and couples into the second tubular member 14 as described herein. When disengagement is desired, the coupling 10 may be actuated as disclosed herein to quickly and safely separate the two coupling 10 member halves 12, 14. For example, with coupling 10 embodiments such as shown in FIG. 1, the crane 205 may be operated to lower and lift the first tubular member 12 for disengagement of the two coupling 10 halves as disclosed herein.

It will be appreciated that embodiments of the disclosed tubular couplings 10 may be implemented for use in numerous applications and operations, in the oil and gas industry and in other fields of endeavor. It will also be appreciated by those skilled in the art that embodiments of this disclosure may be implemented with conventional hardware components (e.g., conventional fasteners, seals, etc.) and parts formed of suitable materials depending on the application (e.g., metal, composites, plastics, synthetic materials, etc.). Parts and components of the embodiments may also be formed via any conventional methods or processes (e.g., casting, water-jet cutting, 3D printing, etc.). Although only a few examples have been described in detail above, those skilled in the art will readily appreciate that many modifications are possible in the examples. Accordingly, all such modifications are intended to be included within the scope of this disclosure as defined in the following claims.

1. A tubular coupling comprising:
a first tubular member;
a second tubular member configured to receive an end of the first tubular member to form a junction;
a locking sleeve disposed on the first tubular member;
the locking sleeve having a plurality of dogs extending therefrom proximate an end of the sleeve;
the second tubular member having a plurality of raised lugs on a surface thereof;
at least one spring disposed on the first tubular member and configured to facilitate rotation of the locking sleeve about a longitudinal axis of the first tubular member;
wherein the locking sleeve is configured to rotate such that the plurality of dogs thereon:
a) engage with the plurality of raised lugs on the second tubular member to form a locking engagement; and
b) disengage from the plurality of raised lugs on the second tubular member to allow separation of the first tubular member from the second tubular member.

2. The tubular coupling of claim 1 further comprising:
a first plurality of fingers disposed on the first tubular member;
a second plurality of fingers disposed on the second tubular member;
the first and second plurality of fingers being configured to interlace with one another upon coupling of the first tubular member with the second tubular member.

3. The tubular coupling of claim 2 further comprising a plurality of guide bars disposed on the second tubular member and configured to guide the plurality of dogs on the sleeve:
c) into the locking engagement with the plurality of raised lugs on the second tubular member; and
d) to disengage from the plurality of raised lugs on the second tubular member.

4. The tubular coupling of claim 2 wherein the first and second plurality of fingers are configured to keep the first tubular member and the second tubular member from rotating with respect to one another when the fingers are interlaced with one another.

5. The tubular coupling of claim 1 wherein the first tubular member comprises a plurality of springs disposed thereon to facilitate rotation of the locking sleeve in a clockwise and/or counterclockwise direction with respect to a longitudinal axis of the first member.

6. The tubular coupling of claim 1 wherein the plurality of raised lugs on the second tubular member are configured to form a plurality of channels along a longitudinal axis of the second member.

7. The tubular coupling of claim 1 wherein an end of the first tubular member and/or an end of the second tubular member is configured to link to a separate device.

8. A tubular coupling comprising:
a first tubular member;
a second tubular member configured to link with the first tubular member to form a junction;
a locking sleeve disposed on the first tubular member;
the locking sleeve having a plurality of dogs extending therefrom proximate an end of the sleeve;
the second tubular member having a plurality of raised lugs on a surface thereof;
a first spring disposed on the first tubular member and configured to facilitate rotation of the locking sleeve in one direction about a longitudinal axis of the first tubular member;
a second spring disposed on the first tubular member and configured to facilitate rotation of the locking sleeve about the longitudinal axis of the first tubular member in a direction opposite the direction facilitated by the first spring;
wherein the locking sleeve is configured to rotate such that the plurality of dogs thereon:
a) engage with the plurality of raised lugs on the second tubular member to form a locking engagement; and
b) disengage from the plurality of raised lugs on the second tubular member to allow separation of the first tubular member from the second tubular member.

9. A method of forming a releasable coupling between a first tubular member and a second tubular member, comprising:
linking the first tubular member with the second tubular member to enable rotation of a locking sleeve on the first tubular member about a longitudinal axis of the member;
wherein at least one spring is disposed on the first tubular member to facilitate rotation of the locking sleeve;
forming a locking engagement between the first tubular member and the second tubular member by enabling rotation of the locking sleeve until a plurality of dogs on the sleeve engage with a plurality of raised lugs on the second tubular member; and
disengaging the plurality of dogs on the locking sleeve from the raised lugs on the second tubular member by enabling further rotation of the locking sleeve to allow separation of the first tubular member from the second tubular member.

10. The method of claim 9 wherein the first tubular member comprises a first plurality of fingers, the second tubular member comprises a second plurality of fingers, and the first and second plurality of fingers are configured to interlace with one another upon coupling of the first tubular member with the second tubular member.

11. The method of claim 9 wherein the first tubular member comprises a plurality of springs disposed thereon to facilitate rotation of the sleeve in a clockwise and/or counterclockwise direction with respect to a longitudinal axis of the first member.

12. The method of claim 9 wherein the plurality of raised lugs on the second tubular member are configured to form a plurality of channels along a longitudinal axis of the second member.

13. The method of claim 9 wherein the first tubular member comprises at least one locking pin to retain the at least one spring on the member.

14. The method of claim 9 wherein the first tubular member comprises a first spring disposed thereon to facilitate rotation of the locking sleeve in one direction about a longitudinal axis of the first tubular member, and a second spring disposed thereon to facilitate rotation of the locking sleeve about the longitudinal axis in a direction opposite the direction facilitated by the first spring.

15. The method of claim 9 further comprising linking the first tubular member to a device and/or linking the second tubular member to another device, prior to linking the first tubular member with the second tubular member.
